(19) United States
(12) Patent Application Publication
(10) Pub. No.: US 2014/0149692 A1
(43) Pub. Date: May 29, 2014

(54) MEMORY CONTROLLER AND OPERATING METHOD OF MEMORY CONTROLLER

(71) Applicant: Samsung Electronics Co., Ltd., Suwon-si (KR)

(72) Inventors: Eunchan KIM, Suwon-si (KR); Hojun SHIM, Yongin-si (KR)

(73) Assignee: SAMSUNG ELECTRONICS CO., LTD., Suwon-si (KR)

(21) Appl. No.: 14/090,042

(22) Filed: Nov. 26, 2013

(30) Foreign Application Priority Data
Nov. 27, 2012 (KR) 10-2012-0135380

(51) Int. Cl. G06F 3/06

(52) U.S. Cl. CPC G06F 3/0659; G06F 3/0604; G06F 3/0673
USPC 711/154

(57) ABSTRACT

A memory controller and an operating method of a memory controller are provided. The operating method includes receiving a command issue from the external host; fetching a command corresponding to the command issue from a memory of the external host in response to the command issue; and controlling the external memory to perform the fetched command. The command is fetched immediately after the command issue is received independently from an execution of a previously fetched command. The memory controller includes a first interface which communicates with a host; and a second interface which communicates with the first interface and with an external memory and is recognized as storage by the host. The memory controller performs the operating method,

### CROSS-REFERENCE TO RELATED APPLICATIONS

This application claims priority from Korean Patent Application No. 10-2012-0135380 filed Nov. 27, 2012, in the Korean Intellectual Property Office, the entire contents of which are hereby incorporated by reference.

### BACKGROUND

1. Field

Methods, devices and articles of manufacture consistent with the present disclosure relate to a semiconductor memory, and more particularly, relate to a memory controller and an operating method of the memory controller.

2. Description of Related Art

A semiconductor memory device is a memory device which is fabricated using semiconductors such as silicon (Si), germanium (Ge), gallium arsenide (GaAs), indium phosphide (InP), and so on. Semiconductor memory devices are classified into volatile memory devices and nonvolatile memory devices.

The volatile memory devices may lose stored contents at power-off. Examples of volatile memory devices include a static RAM (SRAM), a dynamic RAM (DRAM), a synchronous DRAM (SDRAM), and the like. The nonvolatile memory devices may retain stored contents even at power-off. Examples of nonvolatile memory devices include a read only memory (ROM), a programmable ROM (PROM), an electrically programmable ROM (EPROM), an electrically erasable and programmable ROM (EEPROM), a flash memory device, a phase-change RAM (PRAM), a magnetic RAM (MRAM), a resistive RAM (RRAM), a ferroelectric RAM (FRAM), and so on.

A semiconductor memory device may perform write, read and erase operations according to a control of a memory controller. The memory controller may control the semiconductor memory device according to an instruction of a host. The memory controller may provide an interface between the host and the semiconductor memory device.

A device in which a nonvolatile memory device and a controller controlling the nonvolatile memory device are combined may be used for a storage used to store data for a long time. Improvement of operating speed of the host may require high-speed storage.

### SUMMARY

According to an aspect of an exemplary embodiment, there is provided an operating method of a memory controller which is connected with an external host and controls an external memory, the operating method comprising receiving a command issue from the external host; fetching a command corresponding to the command issue from a memory of the external host in response to the command issue; and controlling the external memory to perform the fetched command, wherein the command is fetched immediately after the command issue is received independently from an execution of a previously fetched command.

A second command is fetched in response to a second command issue while the first command fetched is executed.

When the execution of the first command fetched is completed, the second command fetched is executed.

A communication between the external host and the memory controller is performed on the basis of an interface which is included in the memory controller and is recognized as storage by the external host.

A communication between the external host and the memory controller is performed on the basis of an Advanced Host Controller Interface (AHCI) included in the memory controller.

The fetching a command comprises fetching a command header from the memory of the external host in response to the command issue; and fetching a command frame from the memory of the external host based on the command header.

When the command issue is received, one of slots in a first internal register is set to indicate that a command issue exists.

The fetching a command comprises fetching the command in response to the setting of the slot of the first internal register; and setting a slot of a second internal register corresponding to the set slot of the first internal register in response to the fetching of the command.

The command is executed in response to the setting of the slot of the second internal register.

The operating method further comprises clearing slots of the first and second internal registers corresponding to the executed command when the execution of the command is completed.

According to an aspect of another exemplary embodiment, there is provided a memory controller which comprises a first interface which communicates with a host; and a second interface which communicates with the first interface and an external memory and is recognized as storage by the host, wherein the second interface fetches a command from a memory of the host in response to a command issue transferred through the first interface from the host and controls the external memory in response to the fetched command; and wherein the second interface fetches the command whenever the command issue is transferred, independently from a control of the external memory.

The second interface comprises a first register configured to be set according to the command issue transferred through the first interface; a command register configured to fetch the command through the first interface from the host in response to the setting of the first register; a second register configured to be set in response to a command fetch of the command register; and a state machine configured to execute the command fetched by the command register in response to the setting of the second register.

The first register includes a plurality of first slots and the first slots are set by different command issues, respectively.

The command register includes a plurality of command slots corresponding to the first slots respectively and is configured to fetch a command from a corresponding command slot whenever one of the slots is set, independently from an operation of the state machine.

When an execution of the fetched command through the state machine is completed, the first register, the command register and the second register are cleared.

According to an aspect of another exemplary embodiment, there is provided an operating method of a memory controller which is connected with an external host and controls an external memory, the operating method comprising receiving a first command issue from the external host; fetching a first command corresponding to the first command issue, from a system memory of the external host in response to the first command issue; controlling the external memory to start executing the fetched first command; and receiving a second command issue before the execution of the fetched first command is completed.

### BRIEF DESCRIPTION OF THE DRAWINGS

The above and other aspects will become apparent from the following description with reference to the accompanying drawings, wherein like reference numerals refer to like parts throughout the various figures unless otherwise specified, and wherein:

FIG. 1 is a block diagram schematically illustrating a computing system according to an exemplary embodiment;

FIG. 2 is a flowchart schematically illustrating an operating method of a memory controller of FIG. 1 according to an exemplary embodiment;

FIG. 3 is a flowchart schematically illustrating an operation of a computing system of FIG. 1;

FIG. 4 is a block diagram schematically illustrating a memory controller according to an exemplary embodiment;

FIG. 5 is a block diagram schematically illustrating a storage engine of the memory controller of FIG. 4 according to an exemplary embodiment;

FIG. 6 is a flowchart schematically illustrating an operating method of a second interface of FIG. 5 according to an exemplary embodiment;

FIG. 7 is a diagram showing variations in values of slots of first, second and command registers of FIG. 5 when a plurality of command issues is generated; and

FIG. 8 is a block diagram schematically illustrating a storage according to another exemplary embodiment.

### DETAILED DESCRIPTION

Exemplary embodiments will be described in detail with reference to the accompanying drawings. The inventive concept, however, may be embodied in various different forms, and should not be construed as being limited only to the illustrated exemplary embodiments. Rather, these exemplary embodiments are provided as examples so that this disclosure will be thorough and complete, and will fully convey the concept of the inventive concept to those skilled in the art. Accordingly, known processes, elements, and techniques are not described with respect to some of the exemplary embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular exemplary embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Below, the terms “setting” and “clear” of a register (or, a register slot) will be defined. The setting of a register may include an operation of changing a value stored at the register to “0” or “1”. The clear of a register (or, a register slot) may include an operation of changing a value stored at a register (or, a register slot) to “1” or “0”.

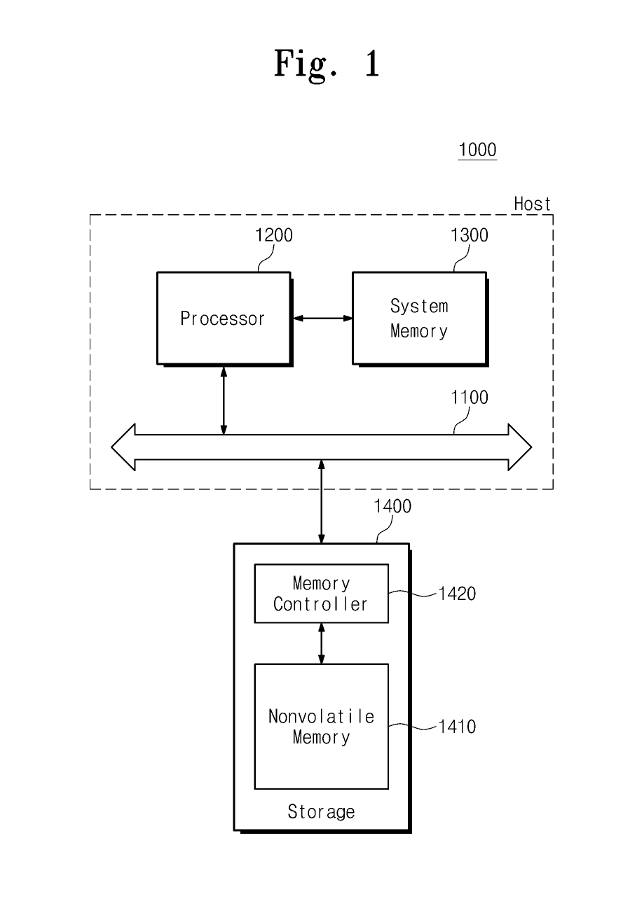

FIG. 1 is a block diagram schematically illustrating a computing system 1000 according to an exemplary embodiment. Referring to FIG. 1, a computing system 1000 may include a bus 1100, a processor 1200, a system memory 1300, and storage 1400. The processor 1200 may be one or more hardware microprocessors.

The bus 1100 may provide a channel between constituent elements of the computing system 1000. For example, the bus 1100 may provide a channel between the processor 1200 and the storage 1400. The bus 1100 may operate based on a standard interface of the computing system 1000. For example, the bus 1100 may operate based on a Peripheral Component Interconnect express (PCIe) interface. However, the bus 1100 is not limited to the PCIe interface. The bus 1100 may be applied to devices which operate based on various interfaces providing channels between various constituent elements.

The processor 1200 may be configured to control constituent elements of the computing system 1000. For example, the processor 1200 may access the system memory 1300 and control the storage 1400 through the bus 1100. The processor 1200 may control the storage 1400 based on the PCIe interface. The processor 1200 may include a general purpose processor and/or an application processor.

The system memory 1300 may be configured to communicate with the processor 1200. The system memory 1300 may include a volatile memory such as an SRAM, a DRAM, an SDRAM, or the like, or a nonvolatile memory such as a phase change RAM (PRAM), a magnetic RAM (MRAM), a resistive RAM (RRAM), a ferroelectric RAM (FRAM), or the like.

The storage 1400 may be configured to communicate with the processor 1200 through the bus 1100. For example, the storage 1400 may communicate with the processor 1200 and the system memory 1300 based on the PCIe interface. The storage 1400 may be used to retain data for a long time. The storage 1400 may include a nonvolatile memory 1410 and a memory controller 1420.

The nonvolatile memory 1410 may include at least one nonvolatile memory. For example, the nonvolatile memory may be a memory such as a flash memory, a phase change RAM (PRAM), a magnetic RAM (MRAM), a resistive RAM (RRAM), a ferroelectric RAM (FRAM), and the like.

The memory controller 1420 may communicate with the processor 1200 through the bus 1100 and control the nonvolatile memory 1410. For example, the memory controller 1420 may communicate with the processor 1200 through the PCIe interface.

The memory controller 1420 may include an interface which is recognized as storage by the bus 1100 or the processor 1200. For example, if the storage 1400 is connected with the bus 1100, the memory controller 1420 may perform predetermined communication with the processor 1200 and/or the bus 1100. According to a result of the predetermined communication, the storage 1400 may be recognized as storage by the bus 1100 and/or the processor 1200. That is, the memory controller 1420 may communicate with the processor 1200 and the system memory 1300 based on a standard interface (e.g., PCIe) of the computing system 1000, and may include an interface which is recognized as storage by the bus 1100 and/or the processor 1200.

The bus 1100, the processor 1200 and the system memory 1300 may constitute a host of the storage 1400.

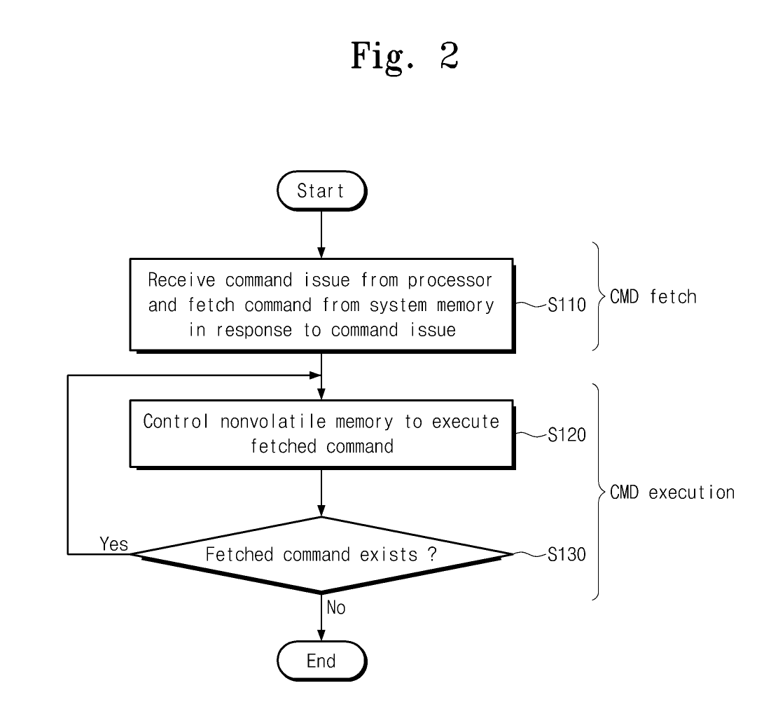

FIG. 2 is a flowchart schematically illustrating an operating method of a memory controller 1420 of FIG. 1 according to an exemplary embodiment. Referring to FIGS. 1 and 2, in operation S110, a memory controller 1420 may receive a command issue from a processor 1200, and may fetch a command from a system memory 1300 in response to the command issue.

The command issue may be a message informing that a command to be transferred is generated. In response to the command issue, the memory controller 1420 may fetch a command, stored at a specific storage area of the system memory 1300, through the processor 1200.

In operation S120, the memory controller 1420 may control a nonvolatile memory 1410 to execute the fetched command. For example, the memory controller 1420 may control the nonvolatile memory 1410 according to the fetched command to perform a write, read or erase operation.

In operation S130, the memory controller 1420 may determine whether a fetched command exists (S130). If it is determined that the fetched command exists, the memory controller 1420 may execute the fetched command (S120). If it is determined that the fetched command does not exist, the memory controller 1420 may end execution of a command.

Operation S110 may correspond to a command fetch operation (CMD fetch) in which the memory controller 1420 fetches a command in response to a command issue. Operations S120 and S130 may correspond collectively to a command execution operation (CMD execution) in which the memory controller 1420 executes a fetched command. The command fetch operation may be performed independently from the command execution operation. For example, the memory controller 1420 may perform the command fetch operation whenever a command issue is generated, regardless of whether the nonvolatile memory 1410 is controlled to perform a command. The memory controller 1420 may perform the command fetch operation when a fetched command exists, regardless of whether a command fetch is being performed.

If the command fetch operation and the command execution operation are performed in parallel, delay in execution of a command (wait) may be prevented during a command fetch operation and delay in execution of a command fetch (wait) may be prevented during a command execution operation. That is, communications between the processor 1200 and the system memory 1300, and between the processor 1200 and the memory controller 1420 may be performed in parallel with communications between the nonvolatile memory 1410 and the memory controller 1420. Thus, it is possible to improve an operating speed.

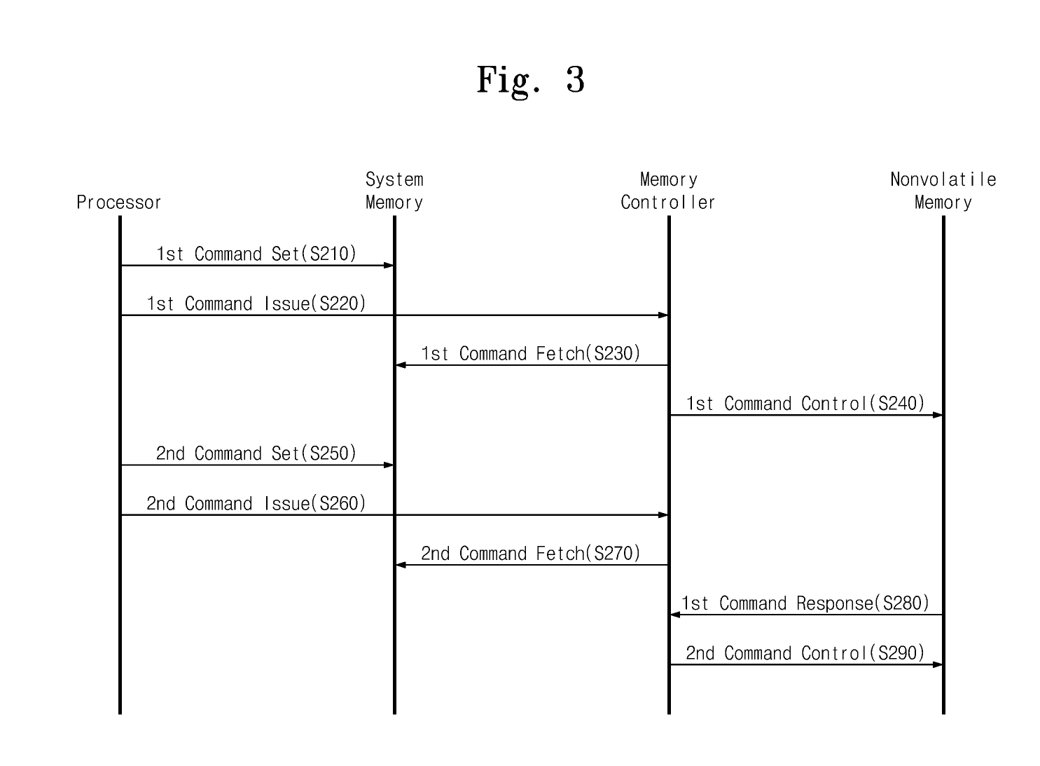

FIG. 3 is a flowchart schematically illustrating an operation of a computing system 1000 of FIG. 1. Referring to FIGS. 1 and 3, in operation S210, a processor 1200 may set a first command in a system memory 1300 through the bus 1100. For example, the processor 1200 may store the first command in a predetermined area of the system memory 1300. The first command may include a command header CH and a command frame CFIS (Command Frame Information Structure).

The command header CH may be stored in a predetermined slot of the system memory 1300. The command frame CFIS may be stored in a predetermined storage area of the system memory 1300. The command header CH may include information on a site where the command frame CFIS is stored.

In operation S220, the processor 1200 may send a first command issue to a memory controller 1420 through the bus 1100. For example, the processor 1200 may set an internal register of the memory controller 1420 indicating that a command is issued. The processor 1200 may set a slot of the internal register of the memory controller 1420 associated with a slot of the system memory 1300 at which the command header CH of the first command is stored.

In operation S230, the memory controller 1420 may fetch the first command through the bus 1100 and the processor 1200 from the system memory 1300 in response to the first command issue. For example, the memory controller 1420 may fetch the command header CH from a slot of the system memory 1300 associated with a slot of the set register. The memory controller 1420 may fetch the command frame CFIS from the system memory 1300, based on the fetched command header CH.

In operation S240, the memory controller 1420 may control the nonvolatile memory 1410 by a first command control in response to the fetched command.

In operation S250, the processor 1200 may set the system memory 1300 with a second command before a control of the nonvolatile memory 1410 according to the first command control is completed.

In operation S260, the processor 1200 may transmit a second command issue to the memory controller 1420 before control of the nonvolatile memory 1410 according to the first command control is completed.

In operation S270, the memory controller 1420 may fetch the second command from the system memory 1300 before control of the nonvolatile memory 1410 according to the first command control is completed.

In operation S280, after a fetch of the second command is completed, a control of the nonvolatile memory 1410 according to the first command control may be completed. Afterwards, in operation S290, the memory controller 1420 may control the nonvolatile memory 1410 by a second command control according to the second command fetched.

As described with reference to FIG. 3, the memory controller 1420 may fetch a command while the nonvolatile memory 1410 is being controlled. Also, the memory controller 1420 may control the nonvolatile memory 1410 while a command is being fetched.

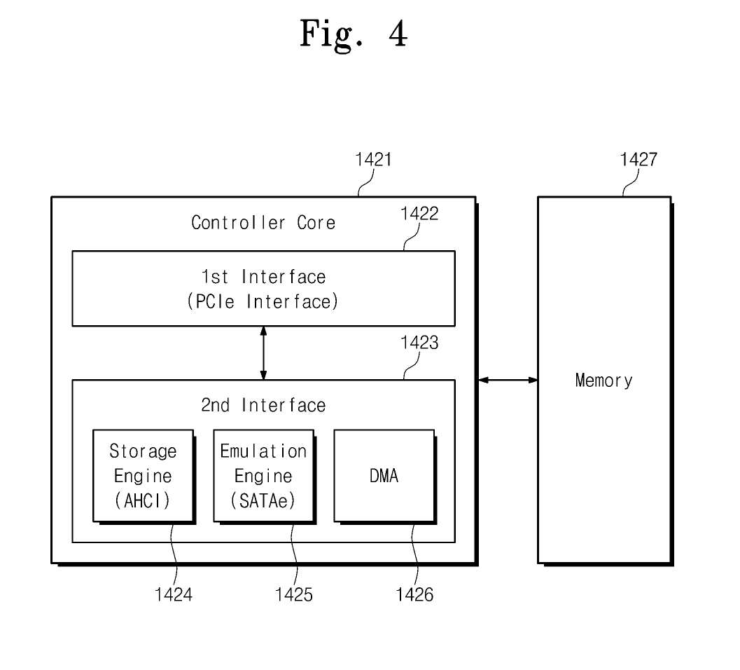

FIG. 4 is a block diagram schematically illustrating a memory controller 1420 according to an exemplary embodiment. Referring to FIGS. 1 and 4, a memory controller 1420 may include a controller core 1421 and a memory 1427. The controller core 1421 may use the memory 1427 as a working memory and/or a buffer memory.

The memory 1427 may include a volatile memory such as an SRAM, a DRAM, an SDRAM, or the like, and/or a nonvolatile memory such as a phase change RAM (PRAM), a magnetic RAM (MRAM), a resistive RAM (RRAM), a ferroelectric RAM (FRAM), or the like.

The controller core 1421 may include a first interface 1422 and a second interface 1423.

The first interface 1422 may communicate with a bus 1100 based on a standard interface of the computing system 1000. For example, the first interface 1422 may include a PCIe interface as a standard interface of the bus 1100 in the computing system 1000.

The second interface 1423 may communicate with the bus 1100 in the computing system 1000 through the first interface 1422, and may communicate with a nonvolatile memory 1410. The second interface 1423 may include an interface which is recognized as storage by the processor 1200 and/or the bus 1100.

The second interface 1423 may include a storage engine 1424, an emulation engine 1425, and a Direct Memory Access (DMA) 1426.

The storage engine 1424 may include an interface which is recognized as storage by the processor 1200 and/or the bus 1100. For example, the storage engine 1424 may include an Advanced Host Control Interface (AHCI). However, the inventive concept is not limited thereto. The storage engine 1424 may include various interfaces recognized as storage by a standard interface of the processor 1200 and/or the computing system 1000, without installation of a separate driver.

The emulation engine 1425 may emulate a storage interface which is configured for the storage engine 1424 to control. For example, the AHCI may be configured to control a Serial AT Attachment (SATA) interface. When the storage engine 1424 includes the AHCI, the emulation engine 1425 may emulate an SATA or SATA express (SATAe) interface. The emulation engine 1425 may be provided for a normal operation.

For example, the AHCI may be configured to communicate with an upper constituent element (e.g., a processor 1200 and/or a bus 1100 of a computing system 1000) through a PCIe interface and to communicate with a lower constituent element (e.g., storage 1400) through the SATA (or, SATAe) interface. The AHCI may operate normally when both an upper channel and a lower channel operate according to the specification. Thus, the emulation engine 1425 may be provided to secure a normal operation of the storage engine 1424.

The DMA 1426 may support an access of the controller core 1421 to the memory 1427.

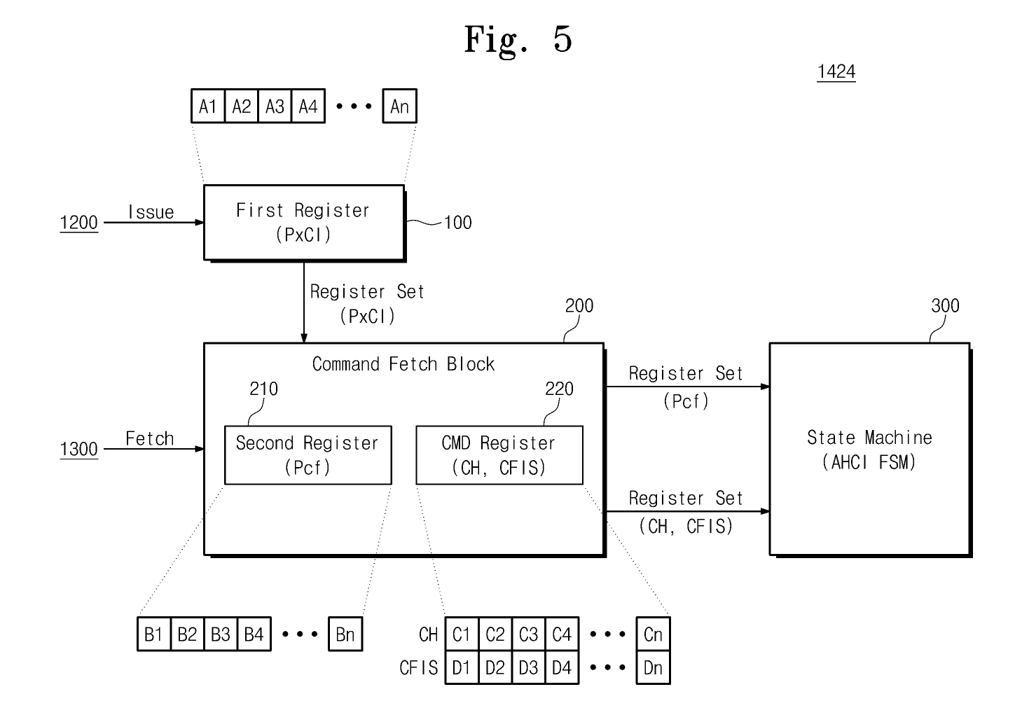

FIG. 5 is a block diagram schematically illustrating a storage engine 1424 of FIG. 4. Referring to FIGS. 1, 4, and 5, a storage engine 1424 may include a first register 100, a command fetch block 200, and a state machine 300.

The first register 100 may include a plurality of slots A1 to An. The first register 100 may receive a command issue through the bus 1100 and the first interface 1422 from the processor 1200. For example, one of the slots A1 to An of the first register 100 may be set by the command issue. For example, the first register 100 may be, for example, a PxCI register which is defined by the AHCI specification.

The command fetch block 200 may include a second register 210 and a command (CMD) register 220. A structure of the second register 210 may be equal to that of the first register 100. The second register 210 may include a plurality of slots B1 to Bn, and the slots B1 to Bn of the second register 210 may correspond to the slots A1 to An of the first register 100, respectively.

The command register 220 may include a plurality of slots C1 to Cn. The command register 220 may include command header (CH) slots C1 to Cn and command frame (CFIS) slots D1 to Dn. The number of the command header slots C1 to Cn may correspond to that of the slots A1 to An or B1 to Bn of the first or second register 100 or 200, respectively. The command frame slots D1 to Dn may correspond to that of the slots A1 to An or B1 to Bn of the first or second register 100 or 200, respectively.

The command fetch block 200 may fetch a command in response to setting of the slots A1 to An of the first register 100. The command fetch block 200 may fetch a command header CH corresponding to a set slot of the first register 100 through the first interface 1422 and the bus 1100 from the system memory 1300. The fetched command header CH may be stored in a slot, corresponding to the set slot of the first register 100, from among the command header slots C1 to Cn of the command register 220.

The command fetch block 200 may fetch a command frame CFIS through the first interface 1422 and the bus 1100 from the system memory 1300, based on the fetched command header CH. The fetched command frame CFIS may be stored in a slot, corresponding to the set slot of the first register 100, from among the command frame slots D1 to Dn of the command register 220.

The command fetch block 200 may set the second register 210 in response to a fetch of the command frame. For example, the command fetch block 200 may set a slot, corresponding to the set slot of the first register 100, from among the slots B1 to Bn of the second register 210.

The state machine 300 may operate according to the setting of the command fetch block 200. For example, the state machine 300 may receive a command from the command register 220 in response to the setting of the second register 210. For example, if a specific slot of the second register 210 is set, the state machine 300 may read a command header CH and a command frame CFIS from a slot, corresponding to the set slot of the second register 200, from among the slots C1 to Cn and D1 to Dn of the command register 220. The state machine 300 may control an emulation engine 1425 in response to the read command.

In exemplary embodiments, the state machine 300 may be an AHCI FSM (Finite State Machine). The state machine 300 may recognize the second register 210 as a PxCI register defined by the AHCI specification.

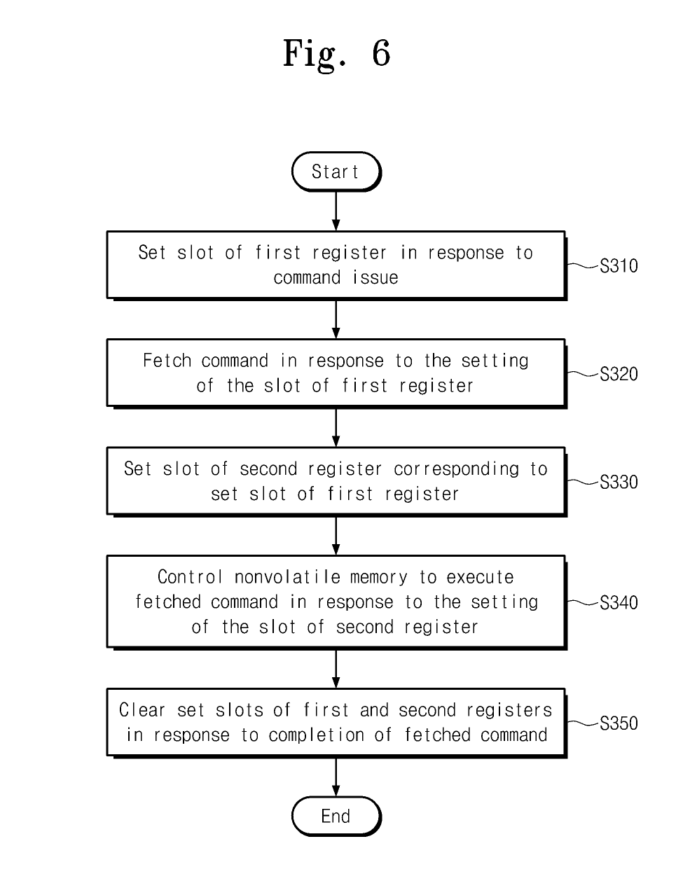

FIG. 6 is a flowchart schematically illustrating an operating method of a second interface 1423 of FIG. 5 according to an exemplary embodiment. In FIG. 6, there is illustrated an operation of a second interface 1423 when a command is generated. Referring to FIGS. 1, 4, 5, and 6, in operation S310, a slot of a first register 100 may be set in response to a command issue. If a command issue is received through the bus 1100 and the first interface 1422 from the processor 1200, a slot, corresponding to the received command issue, from among slots A1 to An of the first register 100 may be set. For example, there may be set a slot of the first register 100 corresponding to a slot of the system memory 1300 at which the processor 1200 stores a command header CH.

In operation S320, a command may be fetched in response to the setting of the slot of the first register 100. For example, a command fetch block 200 may fetch the command header CH through the bus 1100 and the first interface 1422 from a slot of the system memory 1300 corresponding to the set slot of the first register 100. The fetched command header CH may be stored at a slot, corresponding to the set slot of the first register 100, from among command header slots C1 to Cn of a command register 220.

Afterwards, the command fetch block 200 may detect an address of the system memory 1300 at which a command frame CFIS is stored, based on the fetched command header CH. The command fetch block 200 may fetch the command frame CFIS through the bus 1100 and the first interface 1422 from the system memory 1300, based on the detected address. The fetched command frame CFIS may be stored at a slot, corresponding to a set slot of the first register 100, from among command frame slots D1 to Dn of the command register 220.

In operation S330, there may be set a slot of the second register 210 corresponding to the set slot of the first register 100. If a fetch of the command is completed, the command fetch block 200 may set a slot, corresponding to the set slot of the first register 100, from among slots B1 to Bn of a second register 210.

In operation S340, a nonvolatile memory 1410 may be controlled to perform the fetched command in response to the setting of the slot of the second register 210. For example, if a slot of the second register 210 is set, a state machine 300 may read a command header CH and a command frame CFIS from the command register 220. The state machine 300 may control the nonvolatile memory 1410 in response to the read command header CH and command frame CFIS.

In operation S350, slots of the first and second registers 100 and 200 may be cleared in response to a completion of the fetched command. For example, there may be cleared slots of the first and second registers 100 and 200 corresponding to a command completed. Slots of the command register 220 corresponding to the command completed may be also cleared in response to a completion of the fetched command.

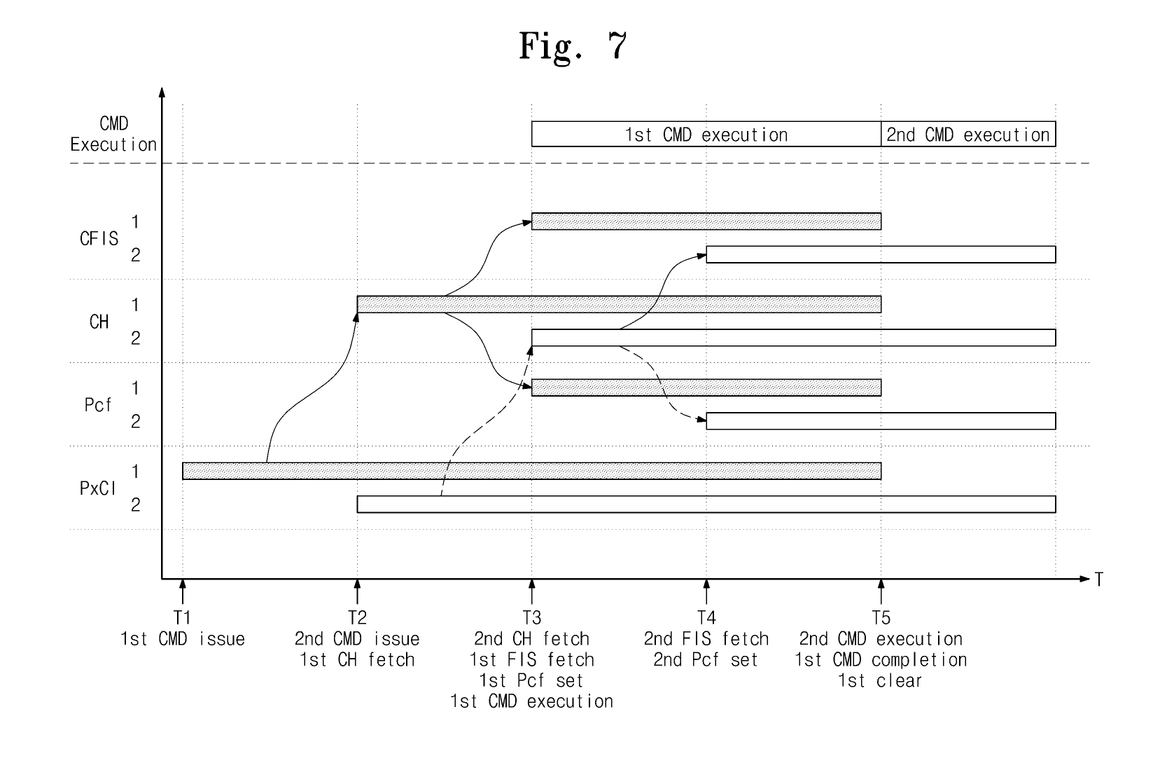

FIG. 7 is a diagram showing variations in values of slots of first, second and command registers 100, 210, and 220 of FIG. 5 when a plurality of command issues is generated. In FIG. 7, there is illustrated an operation in which first and second commands are issued and fetched. Operations of registers corresponding to the first command may be expressed by a box which is filled by shading, and operations of registers corresponding to the second command may be expressed by an empty box.

Referring to FIGS. 5 and 6, at an initial state, slots of first, second and command registers 100, 210, and 220 may have an initial value (e.g., ‘0’).

At T1, a first command may be issued. When the first command is issued, a slot (e.g., a first slot) of the first register 100 (marked by a reference symbol “PxCI”) corresponding to the first command may be set.

At T2, a second command may be issued. When the second command is issued, a slot (e.g., a second slot) of the first register 100 corresponding to the second command may be set.

A command header CH corresponding to the first command may be fetched in response to setting of the first slot of the first register 100. The fetched command header CH may be stored at a slot (e.g., a first command header CH slot) of a command header CH register corresponding to the set slot (e.g., the first slot) of the first register 100.

A command header CH corresponding to the second command may be fetched in response to setting of the second slot of the first register 100. At T3, the fetched command header CH may be stored at a slot (e.g., a second command header slot) of the command header register corresponding to the set slot (e.g., the second slot) of the first register 100.

A command frame CFIS of the first command may be fetched in response to a fetch of the command header CH of the first command. The fetched command frame CFIS may be stored at a slot (e.g., a first command frame slot) of a command frame CFIS register corresponding to the set slot (e.g., the first slot) of the first register 100.

A second register 210 (marked by a reference symbol “Pcf”) may be set together with a fetch of the command frame CFIS of the first command. For example, there may be set a slot (e.g., a first shadow slot) of the second register 210 corresponding to the set slot (e.g., the first slot) of the first register 100. When the first shadow slot is set, a nonvolatile memory 1410 (refer to FIG. 1) may be controlled according to the fetched command header CH and command frame CFIS of the first command. That is, the first command may be executed.

A command frame CFIS of the second command may be fetched in response to a fetch of the command header CH of the second command. At T4, the fetched command frame CFIS may be stored at a slot (e.g., a second command frame slot) of the command frame register corresponding to the set slot (e.g., the second slot) of the first register 100.

The second register 210 (Pcf) may be set when the command frame CFIS is fetched. For example, there may be set a slot (e.g., a second shadow slot) of the second register 210 corresponding to the set slot (e.g., the second slot) of the first register 100.

At T5, an execution of the first command may be completed. Since a slot (e.g., a second shadow slot) of the second register 210 corresponding to the second command was set, the second command may be sequentially executed following the first command.

As described above, a memory controller 1420 may have an interface (e.g., AHCI) which is recognized as storage 1400 by a host. Thus storage 1400 may operate normally through connection with the host without installation of a separate driver. Also, the storage 1400 or the memory controller 1420 may be used without a change of a host structure or interface.

The memory controller 1420 may perform a command fetch operation and a command execution operation independently. When a command issue is generated, the memory controller 1420 may fetch a command. This operation may be performed regardless of whether the nonvolatile memory 1410 is controlled according to a fetched command. When a command is fetched, the memory controller 1420 may set the second register 210 (Pcf). When the second register 210 (Pcf) is set, the memory controller 1420 may execute a command regardless of whether a command is being fetched. A command execution time thus is not delayed by a command fetch time, and the command fetch time is not delayed by the command execution time. Thus, it is possible to improve an operating speed.

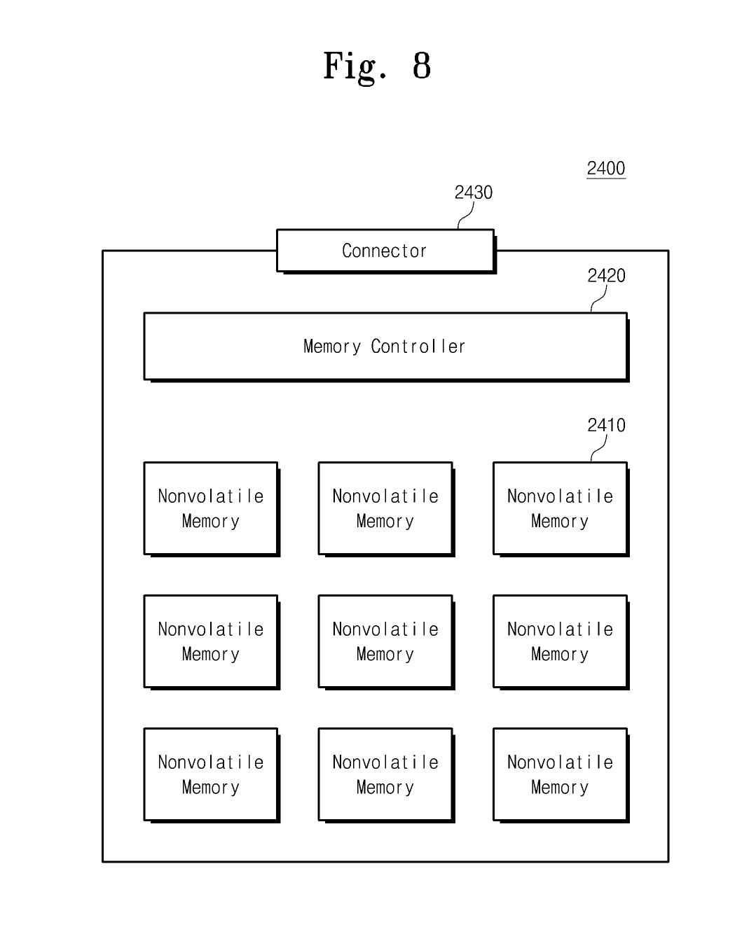

FIG. 8 is a block diagram schematically illustrating storage 2400 according to another exemplary embodiment. Referring to FIG. 8, storage 2400 may include a plurality of nonvolatile memories 2410, a memory controller 2420, and a connector 2430.

The memory controller 2420 may operate substantially the same as described with reference to FIGS. 2 to 7 and thus description will not be repeated here.

The connector 2430 may connect the storage 2400 with a host. For example, the connector 2430 may be a connector of a standard interface used at the host. The connector 2430 may be a connector of a PCIe interface.

The storage 2400 may be a solid state drive (SSD). The storage 2400 may be connected with a host (e.g., a server, a main frame, etc.) which use high-speed and mass storage.

While the inventive concept has been described with reference to exemplary embodiments, it will be apparent to those skilled in the art that various changes and modifications may be made without departing from the spirit and scope of the present inventive concept. Therefore, it should be understood that the above embodiments are not limiting, but illustrative.

What is claimed is:

1. An operating method of a memory controller which is connected with an external host and controls an external memory, the operating method comprising:
receiving a command issue from the external host;
fetching a command corresponding to the command issue from a memory of the external host in response to the command issue; and
controlling the external memory to perform the fetched command,
wherein the command is fetched immediately after the command issue is received independently from an execution of a previously fetched command.

2. The operating method of claim 1, wherein a second command is fetched in response to a second command issue while a first command that is fetched is executed.

3. The operating method of claim 2, wherein in response to completion of the execution of the first command, the second command is executed.

4. The operating method of claim 1, wherein a communication between the external host and the memory controller is performed based on an interface which is included in the memory controller and is recognized as storage by the external host.

5. The operating method of claim 1, wherein a communication between the external host and the memory controller is performed based on an Advanced Host Controller Interface (AHCI) included in the memory controller.

6. The operating method of claim 1, wherein the fetching the command comprises:
fetching a command header from the memory of the external host in response to the command issue; and
fetching a command frame from the memory of the external host based on the command header.

7. The operating method of claim 1, wherein in response to receiving the command issue, one of slots in a first internal register is set to indicate that a command issue exists.

8. The operating method of claim 7, wherein the fetching the command comprises:
fetching the command in response to the setting of the slot of the first internal register; and
setting a slot of a second internal register corresponding to the set slot of the first internal register in response to the fetching of the command.

9. The operating method of claim 8, wherein an execution of the command is made in response to the setting of the slot of the second internal register.

10. The operating method of claim 9, further comprising:
clearing slots of the first and second internal registers corresponding to the executed command in response to completion of an execution of the command.

11. A memory controller comprising:
a first interface which communicates with a host; and
a second interface which communicates with the first interface and with an external memory and is recognized as storage by the host,
wherein the second interface fetches a command from a memory of the host in response to a command issue transferred through the first interface from the host and controls the external memory in response to the fetched command; and
wherein the second interface fetches the command in response to the command issue being transferred, independently from a control of the external memory.

12. The memory controller of claim 11, wherein the second interface comprises:
a first register configured to be set in response to the command issue being transferred through the first interface;
a command register configured to fetch the command through the first interface from the host in response to the setting of the first register;
a second register configured to be set in response to a command fetch of the command register; and
a state machine configured to execute the command fetched by the command register in response to the setting of the second register.

13. The memory controller of claim 12, wherein the first register includes a plurality of first slots and the first slots are set by different command issues, respectively.

14. The memory controller of claim 13, wherein the command register includes a plurality of command slots corresponding to the first slots, respectively, and is configured to fetch a command from a corresponding command slot whenever one of the first slots is set, independently from an operation of the state machine.

15. The memory controller of claim 12, wherein in response to completion of an execution of the fetched command through the state machine, the first register, the command register and the second register are cleared.

16. An operating method of a memory controller which is connected with an external host and controls an external memory, the operating method comprising:
receiving a first command issue from the external host;
fetching a first command corresponding to the first command issue, from a system memory of the external host in response to the first command issue;
controlling the external memory to start executing the fetched first command; and
receiving a second command issue before the execution of the fetched first command is completed.

17. The operating method of claim 16, further comprising:
fetching a second command corresponding to the second command issue, from the system memory before the execution of the fetched first command is completed.

18. The operating method of claim 17, wherein after execution of the fetched first command is completed, controlling the external memory to start executing the fetched second command.

19. The operating method of claim 16, further comprising:
receiving a first command response from the external memory indicating the execution of the first command is completed,
wherein during a time from the start of executing the fetched first command until a time at which the first command response is received, the memory controller receives the second command issue and fetches a second command in response to receiving the second command issue.

20. The operation method of claim 19, wherein the first command is fetched in response to setting a first register of the memory controller, and the external memory is controlled to start executing the fetched first command in response to setting a second register of the memory controller.
